(19) United States
(12) Patent Application Publication
(10) Pub. No.: US 2007/0048341 A1
(43) Pub. Date: Mar. 1, 2007

(54) TickTape

(76) Inventor: Salvatore Joseph Ribera, Wakefield, RI (US)

Correspondence Address: SALVATORE RIBERA, P.O. BOX 522, WAKEFIELD, RI, 02880, US

(21) Appl. No.: 11/131,357

(22) Filed: Aug. 24, 2005

(51) Int. Cl. A01N 25/00

(52) U.S. Cl. 424/405

(57) ABSTRACT

The Problem with hiking in the woods is the infestation of ticks, when attached to the hiker, crawls on the person and attaches itself to the skin. As the tick burrows its head under the skin, it transmits certain diseases, leading to high fever, breathing problems, paralysis, even death in some rare cases. Dealing with this problem would be the application of tick repellant, in this case Deet, in the form of a tape. This tape is soaked in Deet and sold on the market as TickTape, a tick resistant tape which the hiker wraps around his pants and ankles and hikes in the woods without worrying about being bitten and infected by the tick. This proposal will cover the tick and the diseases they carry, the tick repellant known as Deet, and a proposed tick resistant tape called TickTape, and its advantages. Included is a diagram of the tape.

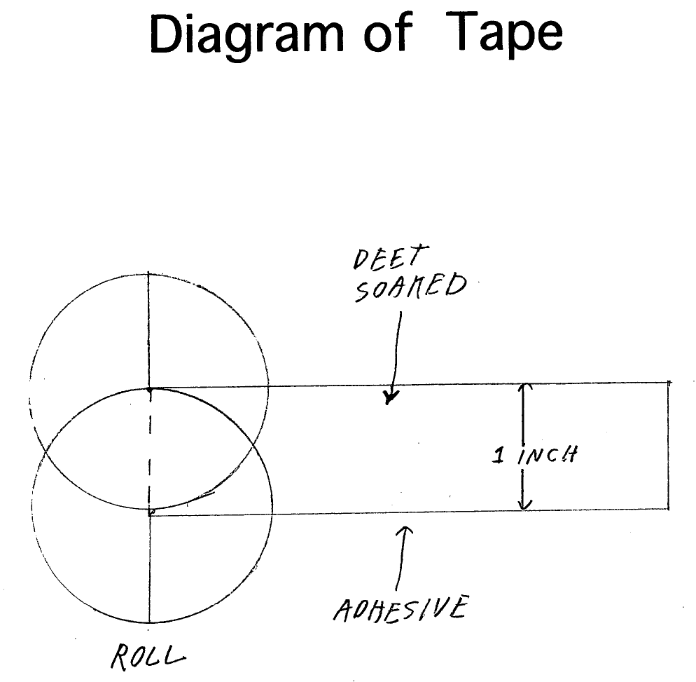

### INTRODUCTION

Purpose

This report proposes a tick repellant tape one could wrap around their feet, ankles, or even the cuffs of their pants when walking in tick infested areas.

Problem

When walking through tall grass or in the woods, one encounters the problem of ticks attaching themselves to the shoes or pants, and then crawling up onto the skin where they can attach themselves, causing various diseases, such as Lyme Disease or Rocky Mountain Spotted Fever. This can be serious, posing problems that require medical treatment.

This is a serious problem considering the number of people who walk in tick infested areas at one time or another, who have a good chance of contracting tick related diseases. Something must be done to greatly decrease this threat.

Scope

This report will briefly cover the tick and its diseases, but will mainly focus on the proposed tick repellant tape than one can wrap around the bottom of their legs, in which, should the tick attach itself to the tape, will merely drop off, preventing any chance the of person contracting a tick related disease.

This will be followed by the type of tape used, what chemical is required, how the tape is packaged, how it can be applied, with an illustration, followed by a conclusion and a recommendation.

### The Tick

A tick is a small, blood sucking mite, with an average length to two to four millimeters. They are the leading carriers of diseases to humans in the United States, second only to mosquitoes worldwide.

The tick sits on tall grasses, trees, low brush, or vegetation, and will extend their legs and get a grip on any passerby. It will then find its way to the skin, to a warm, moist, and dark place on the human body, from the pants or shoe up to the crotch or armpit. It will then insert a probe into the skin and begin to suck blood. The tick burrows with its mouth part into the exposed skin. Their mouth parts are barbed, securing them to the skin.

Ticks need blood to grow and survive, regardless of the animal upon which it feeds. If they cannot find blood, they might die. As they suck the blood of the host, the neurotoxins or organisms in the tick's saliva is transmitted through the bite, causing diseases.

There are over 800 species of ticks throughout the world. They carry many diseases such as Lyme disease and Rocky Mountain Spotted Fever, and several forms of Encephalitis, to name a few. In addition to causing diseases, ticks can also cause Tick Paralysis. This is when neurotoxins in the tick saliva makes one ill, causing paralysis of the body, and in extreme cases, can stop a person from breathing.

There are two groups of ticks that concern human because of the diseases they transmit: hard ticks and soft ticks.

Hard ticks have a tough back plate (called a scutum) that defines their appearance. These ticks tend to attach themselves to the animal and feed for hours, even days. Diseases transmission occurs when the tick is filled with the blood of its victim. Among the types of hard ticks are: American Dog, Wood, Deer (which carry Lyme Disease), and Lone Star.

Soft ticks have more rounded bodies and do not have a hard shell. These ticks usually feed for less than one hour, but disease transmission can occur in less than one minute. The bite of some of these ticks can produce some very painful reactions. Two common soft ticks found in the U.S. are: the Pajaroello tick and the Spinose Ear tick.

Most the time, a person will not know that the tick is on him. The neurotoxins can prevent the victim from feeling the bite and their saliva contains a blood thinner making it easier for the tick to suck the blood.

Also, a tick can leave the victim without the victim contracting any disease, but there is that chance, so there must be a tick repellant to protect the victim in the event of walking in tick infested areas.

### Deet

Deet is an insect repellant patented by the U.S. Army in 1946, for use in heavy infestation. This chemical was developed by the U.S. Department of Agriculture, after the testing of over 11,000 compounds for their effectiveness in repelling insects. Deet proved to be the most effective, that can kill ticks, mosquitoes, fleas, and other annoying insects without harming the person using formula, provided that he uses it correctly.

The chemical compound is C₁₂H₁₇NO; originally known as N,N′-diethyl-m-toluamide, now known as N,n-diethyl-3-milhybenzamide. This contains a minimum of 95% of the meta isomer, the most effective form of the above compound.

This makes Deet a superior insect repellant, effective against most biting insects, regardless of geographic location. Applied to the skin, a formula consisting of 23.8% Deet can last up to five hours, even if the person involved goes in and out of the water. Since Deet has a resistance to sweating and washing of the body, this repellant is good for swimmers and fishermen.

Studies have shown that with higher concentrations, Deet-based repellants have been known to last up to 12 hours. Applied to clothing, Deet has been known to last several days.

Deet does have its properties with which one must be careful. Prolonged exposure to Deet has been associated with neurological damage, and is toxic, even fatal if swallowed. Deet can also damage some plastics and synthetic fabrics, such as nylon and acetate, so one must be careful when applying it to clothing.

Deet, however, is not a skin irritant.

Which brings us back to the problem of ticks and how it can be handled.

### TICKTAPE

TickTape, as the product would be named, is a proposed way of handling the problem of ticks. This tape is soaked in 100% Deet. This would be a situation where the hiker walking in a tick infested area can first wrap this tape around the cuff of his pants, and also around his ankles to close the space between them, to protect his skin. The process would be that his legs, wrapped in TickTape, would protect in hiker from the tick and all its diseases. As the tick crawls on the hiker's legs, where they are taped, the potency of the Deet would make the tick fall off and possibly die, thus protecting the would-be victim from any tick related diseases.

The tape is to be made of a non-synthetic, Deet tolerant fiber, such as cotton. This tape is to be one inch wide and five feet long. About eight inches of the tape would be used on one leg. In purchasing the roll, the Deet would be wrapped in cellophane or come in a tape dispenser to cut the tape. (See illustration, after page 7)

In the process of manufacturing the tape, it is to be soaked in a formula of 100% Deet, the most potent form of the compound. One side of the tape would be adhesive, the other side, bare and Deet soaked. Note that the chemical would never touch the hiker's skin. This is an advantage because the chemical would not have to be sprayed on to moisten the hiker's skin, to spray on clothing that may be damaged due to synthetic fabrics, nor would the hiker have to breathe in the toxic fumes.

### CONCLUSION

As stated, ways to wrap around the legs would be from the boot or ankle to the bottom of the trousers, or wrapped directly on the ankles, so as the tick, when attempting to attach itself to the human skin, would immediately be repelled. This will protect the person involved from tick and any tick related disease, enabling him to safely walk, or hike, in the woods, forests, or any other tick infested area. Also, the hiker would not have to breathe in any toxic fumes nor damage his clothing.

### Recommendation

Begin experimenting with proposed TickTape and market it, selling it to drug stores, sporting goods stores, and any store specializing in the outdoors.

### BIBLIOGRAPHY

1. Atkins, Bridget; “What's New? DEET vs. NON DEET PR,” Tender Corporation, Littleton, N.H., 2004.
   This report tells of repellants containing Deet as opposed to repellants not containing Deet, comparing them for efficiency in repelling pests. This report comes up in favor of Deet.
2. Brandt, Carl J, M.D.; “Ticks,” www.NetDoctor.co.uk., Feb. 16, 2005.
   General questions concerning ticks, and how to deal with them should one come in contact with skin, are presented and answered by Dr. Carl Brandt.
3. Consumer Health Medicine, “Ticks: Ticks Over View,” www.emedicine.com, Jan. 25, 2005.
   Various types of ticks, and their diseases, are covered.
4. Fradin, Mark S., M.D. and Day, John F., PhD.; “Comparative Efficacy of Insect Repellents against Mosquito Bites,” The New England Journal of Medicine, Jul. 4, 2002, Volume 347:13-18.
   This research paper covered experiments with Deet, using certain percentages in the compound on human volunteers, and how they are affected by Deet in repelling mosquitoes. This covers how long each subject is protected from mosquitoes in applying the Deet on both skin and clothing, and what percentage of the compound is necessary in mixing it with other formulas.
5. Helmenstine, Anne Marie, Ph.D.; “About Deet Chemistry—What You Need To Know,” Your Guide to Chemistry.
   General information about Deet, how it works, the hazards, and how to apply it on the skin.
6. Reilly Industries, Inc., “Deet (N,N′-Diethyl-m-toluamide),” Indianapolis, Ind.
   Explains the chemical composition of Deet, its effect on insects, and how it should be applied on clothing and skin. Also explains hazards.

1. I claim that my invention, Ticktape, is of my own original design and idea, and that no other person, living or dead, had any part in this idea.
My claim to Ticktape is that of a tape, soaked in Deet, where one could wrap around one's leg, where acting as a barrier, can prevent ticks from crawling up legs, thus preventing any tick carrying diseases.
It is this concept where the tape would repel ticks from the human body, again, preventing infection and sickness.
